(19) United States
(12) Patent Application Publication
(10) Pub. No.: US 2025/0137799 A1
(43) Pub. Date: May 1, 2025

(54) DEVICE AND METHOD FOR CONTROLLING VEHICLE

(71) Applicants: HYUNDAI MOTOR COMPANY, SEOUL (KR); KIA CORPORATION, SEOUL (KR)

(72) Inventor: Beom Chang Seong, Seoul (KR)

(73) Assignees: HYUNDAI MOTOR COMPANY, SEOUL (KR); KIA CORPORATION, SEOUL (KR)

(21) Appl. No.: 18/774,444

(22) Filed: Jul. 16, 2024

(30) Foreign Application Priority Data
Oct. 27, 2023 (KR) 10-2023-0145797

(51) Int. Cl. G01C 21/36

(52) U.S. Cl. CPC G01C 21/367; G01C 21/3691

(57) ABSTRACT

A device for controlling a vehicle including a communication device in communication with a server, and a processor that transmits at least one of route guidance information provided while the vehicle travels on a route to a destination or traffic information on the route, or any combination thereof to the server, and determines an output point of a pop-up image based on a weight reflecting at least one of an entry failure probability or the traffic information, or any combination thereof received from the server.

### CROSS REFERENCE TO RELATED APPLICATIONS

This application claims the benefit of priority to Korean Patent Application No. 10-2023-0145797, filed in the Korean Intellectual Property Office on Oct. 27, 2023, the entire contents of which are incorporated herein by reference.

### TECHNICAL FIELD

The present disclosure relates to a device and a method for controlling a vehicle, and more specifically, to a device and a method for controlling a vehicle that guides a route to easily enter a junction.

### BACKGROUND

When a destination is input via a navigation system, a route of a vehicle to the destination is guided. When the route to the destination includes entering a junction, a pop-up image is output to inform a driver of junction entry information in advance before reaching the junction. In general, a point where the pop-up image is output is set differently depending on a type of a road on which the vehicle is traveling. In a case of highway where the vehicle travels at a high speed, the pop-up image is set to be output 1 km before the junction, and in a case of general road where the vehicle travels at a low speed, the pop-up image is set to be output 300 m before the junction.

As such, the pop-up image guiding the junction entry information is output in advance of the junction so as to be easily checked by the driver. However, when the driver is not able to recognize the pop-up image during traveling on an unfamiliar road, at night, or in a traffic jam, a probability of not entering the junction increases and a travel time to the destination increases.

### SUMMARY

The present disclosure has been made to solve the above-mentioned problems occurring in the prior art while advantages achieved by the prior art are maintained intact.

An aspect of the present disclosure provides a device and a method for controlling a vehicle that determine an output point of a pop-up image that guides junction entry information such that a driver may easily recognize the pop-up image and safely enter a junction.

Another aspect of the present disclosure provides a device and a method for controlling a vehicle that reduce traffic congestion by preventing unnecessary travel such as a U-turn, re-entry, and re-joining caused by a driver failing to enter a junction.

Another aspect of the present disclosure provides a device and a method for controlling a vehicle that fundamentally prevent a situation in which a driver unreasonably attempts to perform a lane change to avoid missing a junction entry timing, thereby reducing a probability of a collision accident with another vehicle traveling in a line where the vehicle is traveling or a line adjacent thereto.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a device for controlling a vehicle includes a communication device in communication with a server, and a processor that transmits at least one of route guidance information provided while the vehicle travels on a route to a destination or traffic information on the route, or any combination thereof to the server, and determines an output point of a pop-up image based on a weight reflecting at least one of an entry failure probability or the traffic information, or any combination thereof received from the server.

In one implementation, the processor may output the pop-up image including junction entry guidance information when determining that junction entry is scheduled based on the route to the destination, and store the route guidance information including location information for each of one or more junctions where the pop-up image was output, and a history of the pop-up image output matching with the location information.

In one implementation, the processor may output a re-search guidance message when it is determined that junction entry is scheduled based on the route to the destination, but the junction entry is failed, and store the route guidance information including location information for each junction where the re-search guidance message was output and a history of the re-search guidance message output matching with the location information.

In one implementation, the processor may transmit the route guidance information to the server when determining that the vehicle is turned off after reaching the destination.

In one implementation, the processor may receive the entry failure probability calculated by the server based on the route guidance information for each junction received from one or more vehicles.

In one implementation, the processor may reset the route guidance information transmitted to the server when determining that the vehicle is started again after being turned off.

In one implementation, the processor may determine the pop-up image output point by reflecting the weight to a pop-up image output point preset depending on a type of road.

In one implementation, the processor may determine that the pop-up image output point is farther away from the junction than a preset pop-up image output point as the entry failure probability increases.

In one implementation, the processor may determine that the pop-up image output point is farther away from the junction than a preset pop-up image output point as a travel speed decreases when the vehicle travels on a predetermined route including the junction.

In one implementation, the processor may control the pop-up image to be output via an output device at the determined pop-up image output point.

According to another aspect of the present disclosure, a method for controlling a vehicle includes transmitting at least one of route guidance information provided while the vehicle travels on a route to a destination or traffic information on the route, or any combination thereof to a server, and determining an output point of a pop-up image based on a weight reflecting at least one of an entry failure probability or the traffic information, or any combination thereof received from the server.

In one implementation, the method may further include outputting the pop-up image including junction entry guidance information when determining that junction entry is scheduled based on the route to the destination, and storing the route guidance information including location information for each of one or more junctions where the pop-up image was output, and a history of the pop-up image output matching with the location information.

In one implementation, the method may further include outputting a re-search guidance message when it is determined that junction entry is scheduled based on the route to the destination, but the junction entry is failed, and storing the route guidance information including location information for each junction where the re-search guidance message was output and a history of the re-search guidance message output matching with the location information.

In one implementation, the method may further include transmitting the route guidance information to the server when determining that the vehicle is turned off after reaching the destination.

In one implementation, the method may further include receiving the entry failure probability calculated by the server based on the route guidance information for each junction received from one or more vehicles.

In one implementation, the method may further include resetting the route guidance information transmitted to the server when determining that the vehicle is started again after being turned off.

In one implementation, the pop-up image output point may be determined by reflecting the weight to a pop-up image output point preset depending on a type of road.

In one implementation, the pop-up image output point may be determined to be farther away from the junction than a preset pop-up image output point as the entry failure probability increases.

In one implementation, the pop-up image output point may be determined to be farther away from the junction than a preset pop-up image output point as a travel speed decreases when the vehicle travels on a predetermined route including the junction.

In one implementation, the method may further include controlling the pop-up image to be output via an output device at the determined pop-up image output point.

### BRIEF DESCRIPTION OF THE FIGURES

The above and other objects, features and advantages of the present disclosure will be more apparent from the following detailed description taken in conjunction with the accompanying drawings:

FIG. 1 is a diagram showing a configuration of a vehicle control device according to an embodiment of the present disclosure;

FIG. 2 is a diagram schematically showing an output image of an output device according to an embodiment of the present disclosure;

FIG. 3 is a diagram schematically showing route guidance information according to an embodiment of the present disclosure;

FIG. 4 is a diagram schematically showing a vehicle control system according to an embodiment of the present disclosure;

FIG. 5 is a diagram showing a configuration of a server according to an embodiment of the present disclosure;

FIGS. 6 and 7 are diagrams showing a vehicle control method according to an embodiment of the present disclosure; and

FIG. 8 illustrates a configuration of a computing system for executing a method according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

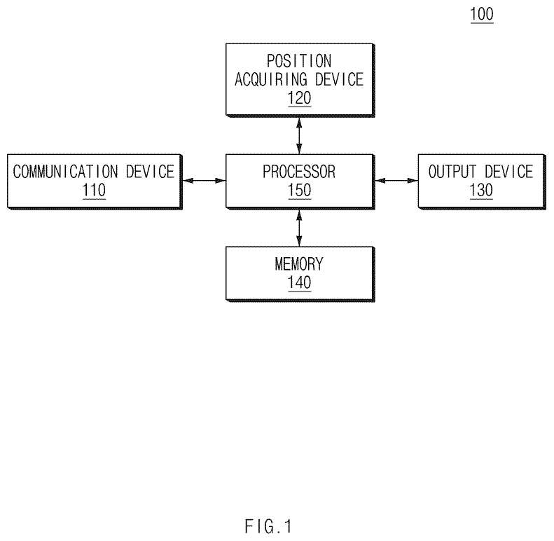

FIG. 1 is a diagram showing a configuration of a vehicle control device according to an embodiment of the present disclosure.

As shown in FIG. 1, a vehicle control device 100 may be mounted on a connected vehicle, and may include a communication device 110, a position acquiring device 120, an output device 130, a memory 140, and a processor 150.

The communication device 110 may perform V2X communication to be in wireless communication with an object or another vehicle around the vehicle, and may also be in the wireless communication with a server 200. According to one embodiment, the communication device 110 may include a transceiver that transmits and receives information using an antenna, a communication circuit, a communication processor, and the like, and may be in communication with the server 200 via various wireless communication schemes such as Wi-Fi, WiBro, global system for mobile communication (GSM), code division multiple access (CDMA), wideband code division multiple access (WCDMA), universal mobile telecommunication system (UMTS), time division multiple access (TDMA), long term evolution (LTE), and the like.

The position acquiring device 120 may be equipped with a GPS receiver and acquire location information of the vehicle and location information of a junction, and may map-match a location of the vehicle to pre-stored map data to provide a map image of an area within a predetermined distance from the location of the vehicle and guide a route to a destination.

The output device 130 may output an image or a sound under control of the processor 150. According to one embodiment, the output device 130 may be implemented as a display device, a sound output device, or the like. In this regard, the display device may include a heads-up display (HUD), a cluster, and the like. According to one embodiment, the display device may be implemented as a display device employing a liquid crystal display (LCD) panel, a light emitting diode (LED) panel, an organic light emitting diode (OLED) panel, a plasma display panel (PDP), or the like. The liquid crystal display may include a thin film transistor-LCD (TFT-LCD). The display device may be integrally implemented with a touch screen panel (TSP).

The memory 140 may store at least one algorithm that performs calculation or execution of various commands for an operation of the vehicle control device according to one embodiment of the present disclosure. According to one embodiment, the memory 140 may store at least one command executed by the processor 150, and the command may cause the vehicle control device of the present disclosure to operate. The memory 140 may include at least one storage medium among a flash memory, a hard disk, a memory card, a read-only memory (ROM), a random access memory (RAM), an electrically erasable programmable read-only memory (EEPROM), a programmable read-only memory (PROM), a magnetic memory, a magnetic disk, and an optical disk.

The processor 150 may be implemented by a variety of processing devices with a built-in semiconductor chip or the like that may calculate or execute the various commands, and may control the operation of the vehicle control device according to one embodiment of the present disclosure. The processor 150 may be electrically connected to the communication device 110, the position acquiring device 120, the output device 130, and the memory 140 via a wired cable or various circuits to transmit an electrical signal including a control command and the like and perform calculation or data processing regarding control and/or communication. The processor 150 may include at least one of a central processing unit, an application processor, or a communication processor (CP), or any combination thereof.

When the vehicle is started and the destination is set, the processor 150 may request the server 200 to search for the route to the destination.

When receiving the route to the destination from the server 200, the processor 150 may control the vehicle to start traveling along the route.

The processor 150 may provide route guidance information that guides the route to the destination during the traveling on the route to the destination, and may acquire traffic information on the route. In this regard, the route guidance information that guides the route to the destination may include junction entry guidance information that guides junction entry when one or more junctions are scheduled to be entered, and route re-search information that includes a re-search guidance message for route re-search when the vehicle fails to perform the scheduled junction entry, deviates from the route, and passes the junction. The traffic information on the route may include traffic conditions (smooth, congested, and delayed) classified based on a travel speed for each road type. Refer to Table 1 for the traffic information according to one embodiment.

TABLE 1

| Division | Smooth | Congested | Delayed |
|---|---|---|---|
| Highway | Vehicle speed equal | Vehicle speed equal | Vehicle |
| | to or higher | to or higher than 30 | speed lower |
| | than 70 km/h | km/h and lower than | than 30 km/h |
| | | 70 km/h | |
| Urban highway | Vehicle speed equal | Vehicle speed equal | Vehicle |
| (driveway) | to or higher | to or higher than 30 | speed lower |
| | than 60 km/h | km/h and lower than | than 30 km/h |
| | | 60 km/h | |
| IC/JC | Vehicle speed equal | Vehicle speed equal | Vehicle |
| | to or higher | to or higher than 20 | speed lower |
| | than 35 km/h | km/h and lower than | than 20 km/h |
| | | 35 km/h | |
| General road | Vehicle speed equal | Vehicle speed equal | Vehicle |
| | to or higher | to or higher than 20 | speed lower |
| | than 40 km/h | km/h and lower than | than 20 km/h |
| | | 40 km/h | |
| Other | Vehicle speed equal | Vehicle speed equal | Vehicle |
| | to or higher | to or higher than 10 | speed lower |
| | than 20 km/h | km/h and lower than | than 10 km/h |
| | | 20 km/h | |

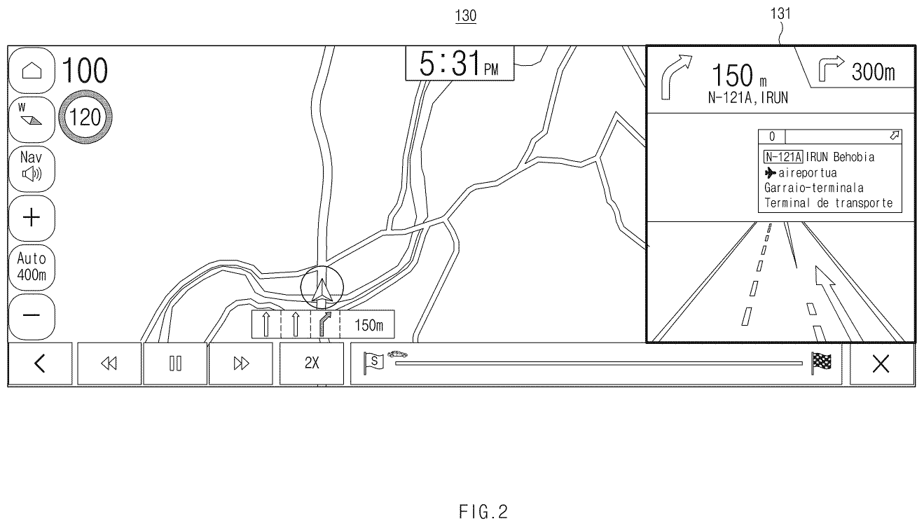

When determining that the junction entry is scheduled based on the route to the destination, the processor 150 may output the pop-up image including the junction entry guidance information. Refer to FIG. 2 for a more detailed description.

FIG. 2 is a diagram schematically showing an output image of an output device according to an embodiment of the present disclosure.

As shown in FIG. 2, the processor 150 may output a pop-up image 131 including the junction entry guidance information at one side of the output device 130. According to one embodiment, the processor 150 may divide a screen of the output device 130 and output the pop-up image 131.

Referring again to FIG. 1, the processor 150 may store the route guidance information including location information of the junction where the pop-up image was output and a history of the pop-up image output matching with the location information of the junction where the pop-up image was output.

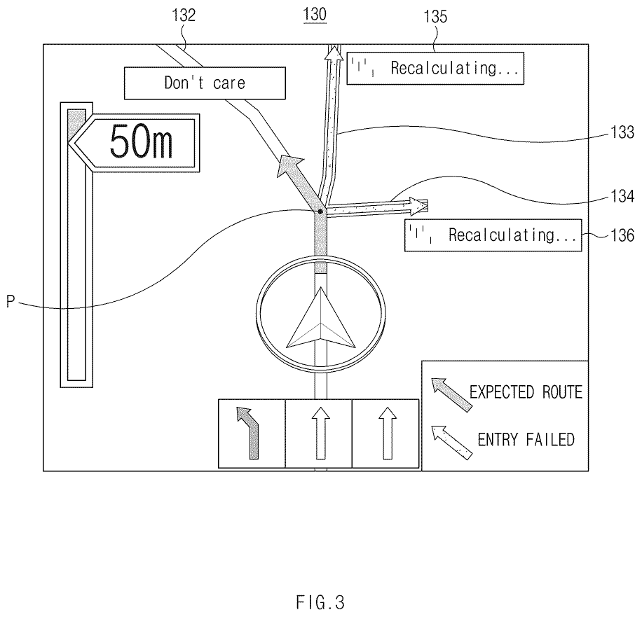

The processor 150 may determine whether the re-search guidance message was output after passing the junction after the junction entry guidance information was output. Refer to FIG. 3 for a more detailed description.

FIG. 3 is a diagram schematically showing route guidance information according to an embodiment of the present disclosure.

As shown in FIG. 3, when it is determined that entry to a junction P is scheduled based on a route 132 to the destination, but the vehicle fails to enter the junction P and travels 133 or 134 deviating from the route, the processor 150 may output a re-search guidance message 135 or 136 that re-searches the route to the destination.

When determining that the re-search guidance message was output, the processor 150 may store the route guidance information including location information of each junction where the re-search guidance message was output and a history of the re-search guidance message output matching with the location information of each junction where the re-search guidance message was output.

The processor 150 may determine whether the destination has been reached.

The processor 150 may store the pop-up image output history for each junction depending on whether the junction entry is scheduled until reaching the destination, and may store the re-search guidance message output history for each junction depending on whether the junction entry is failed.

When determining that the vehicle is turned off after arriving at the destination, the processor 150 may transmit the stored information (the route guidance information) to the server 200, and when the vehicle is started again after being turned off, the processor 150 may delete the stored information and perform information initialization.

When a wireless update is performed from the server 200 while the vehicle is turned off, the processor 150 may receive a calculated entry failure probability for each junction.

When the vehicle is started again after being turned off and a new destination is input, the processor 150 may request the server 200 to search for a route to the new destination.

The processor 150 may control the vehicle to start traveling along the route to the new destination.

The processor 150 may determine whether the junction entry is scheduled based on the route to the new destination.

When determining that the junction entry is scheduled based on the route to the new destination, the processor 150 may determine a pop-up image output point based on a weight reflecting at least one of the entry failure probability for each junction or the traffic information, or any combination thereof received from the server 200.

According to one embodiment, the processor 150 may reflect the weight to the pop-up image output point preset depending on a type of road and determine the pop-up image output point. As an example, the pop-up image output point preset depending on the type of road may be set as shown in Table 2.

TABLE 2

| Type of road | Pop-up image output point |
|---|---|
| Highway | Point 1 km before junction |
| Urban highway | Point 500 m before junction |
| General road | Point 300 m before junction |

According to one embodiment, when the processor 150 determines the pop-up image output point based on the weight reflecting an entry failure probability a for each junction, the pop-up image output point for each type of road may be calculated using Calculation Formulas 1 to 3.

Pop-up image output point (highway) from junction=1000+100*α Calculation Formula 1:

Pop-up image output point from junction (urban highway)=500+100*α Calculation Formula 2:

Pop-up image output point from junction (general road)=300+100*α Calculation Formula 3:

In other words, as the entry failure probability for each junction increases, the processor 150 may determine that the pop-up image output point is farther away from the junction than the preset pop-up image output point.

According to one embodiment, when determining the pop-up image output point based on the weight reflecting the traffic information, the pop-up image output point for each type of road may be determined as shown in Table 3.

TABLE 3

| Traffic information | Highway | Urban highway | General road |
|---|---|---|---|
| Smooth | 1000 + 50(m) | 500 + 50(m) | 300 + 50(m) |
| Congested | 1000 + 100(m) | 500 + 100(m) | 300 + 100(m) |
| Delayed | 1000 + 150(m) | 500 + 150(m) | 300 + 150(m) |

That is, the processor 150 may determine that as the travel speed decreases when the vehicle travels on a predetermined route including the junction, the pop-up image output point is farther away from the junction than the preset pop-up image output point.

According to one embodiment, when the processor 150 determines the pop-up image output point based on the weight reflecting the entry failure probability for each junction and the traffic information, the pop-up image output point for each type of road may be determined as shown in Table 4.

TABLE 4

| Traffic | | | |
|---|---|---|---|
| information | Highway | Urban highway | General road |
| Smooth | 1000 + α*50(m) | 500 + α*50(m) | 300 + α*50(m) |
| Congested | 1000 + α*100(m) | 500 + α*100(m) | 300 + α*100(m) |
| Delayed | 1000 + α*150(m) | 500 + α*150(m) | 300 + α*150(m) |

In other words, as the entry failure probability for each junction increases and the travel speed decreases when the vehicle travels on the predetermined route including the junction, the processor may determine that the pop-up image output point is farther away from the junction than the preset pop-up image output point.

When the pop-up image output point is determined, the processor 150 may change the preset pop-up image output point to the determined pop-up image output point, and output the pop-up image via the output device 130 at the determined pop-up image output point.

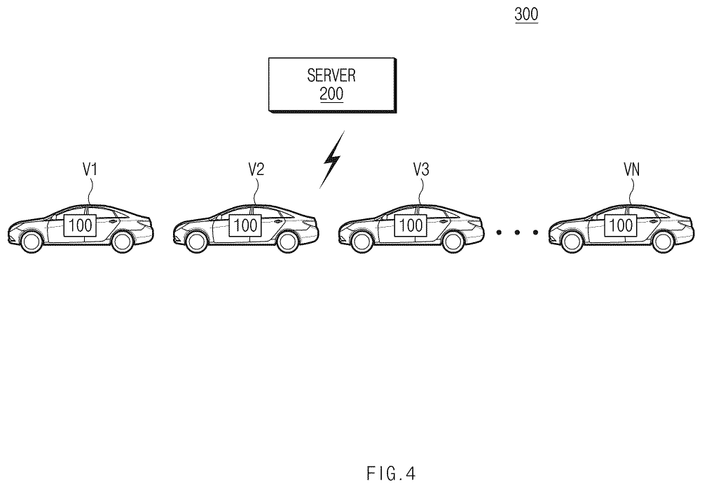

FIG. 4 is a diagram schematically showing a vehicle control system according to an embodiment of the present disclosure.

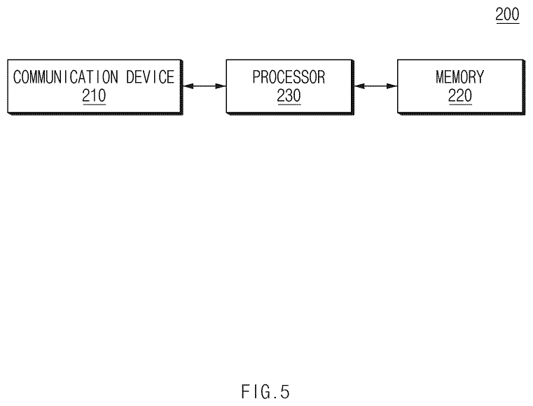

As shown in FIG. 4, a vehicle control system 300 may include the server 200 that is in wireless communication with one or more vehicles V1, V2, V3 . . . VN. The vehicle may be equipped with the vehicle control device 100. Refer to FIG. 5 for a more detailed description of the server 200.

FIG. 5 is a diagram showing a configuration of a server according to an embodiment of the present disclosure.

As shown in FIG. 5, the server 200 may include a communication device 210, a memory 220, and a processor 230.

The communication device 210 may be in the wireless communication with the one or more vehicles. According to one embodiment, the communication device 210 may include a transceiver that transmits and receives information using an antenna, a communication circuit, a communication processor, and the like, and may be in the communication with the one or more vehicles in various communication schemes such as Wi-Fi, WiBro, global system for mobile communication (GSM), code division multiple access (CDMA), wideband code division multiple access (WCDMA), universal mobile telecommunication system (UMTS), time division multiple access (TDMA), long term evolution (LTE), and the like.

The memory 220 may store at least one algorithm that performs calculation or execution of various commands for an operation of the server according to one embodiment of the present disclosure. According to one embodiment, the memory 220 may store at least one command executed by the processor 230, and the command may cause the vehicle control device of the present disclosure to operate. The memory 220 may include at least one storage medium among a flash memory, a hard disk, a memory card, a read-only memory (ROM), a random access memory (RAM), an electrically erasable programmable read-only memory (EEPROM), a programmable read-only memory (PROM), a magnetic memory, a magnetic disk, and an optical disk.

The processor 230 may be implemented by a variety of processing devices with a built-in semiconductor chip or the like that may calculate or execute the various commands, and may control the operation of the server according to one embodiment of the present disclosure. The processor 230 may be electrically connected to the communication device 210 and the memory 220 via a wired cable or various circuits and transmit an electrical signal including a control command and the like, and may perform calculation or data processing regarding control and/or communication. The processor 230 may include at least one of a central processing unit, an application processor, or a communication processor (CP), or any combination thereof.

The processor 230 may receive, from the one or more vehicles, the location information for each junction where the pop-up image was output acquired from the vehicle, and information on the pop-up image output history matching with the location information for each junction where the pop-up image was output.

The processor 230 may receive, from the one or more vehicles, location information (i,j,k) for each junction where the re-search guidance message was output acquired from the vehicle, and information on the re-search guidance message output history matching with the location information (i,j,k) for each junction where the re-search guidance message was output.

The processor 230 may calculate the number of times the pop-up image was output for each junction and calculate the number of times the re-search guide image was output for each junction based on the information received from the one or more vehicles.

The processor 230 may calculate the junction entry failure probability for each junction based on the number of times (TOTAL_{(x)(i,j,k)}) the pop-up image was output for each junction and the number of times (FAIL_{(x)(i,j,k)}) the re-search guide image was output for each junction. According to one embodiment, the processor 230 may calculate the junction entry failure probability α for each junction using Calculation Formula 4.

$${α}_{( i , j , k )} = \frac{{Σ}_{x = 1}^{N} {FAIL}_{( x ) ( i , j , k )}}{{Σ}_{x = 1}^{N} {TOTAL}_{( x ) ( i , j , k )}} \qquad Calculation Formula 4$$

When the junction entry failure probability for each junction is calculated, the processor 230 may transmit the calculated junction entry failure probability for each junction to each vehicle.

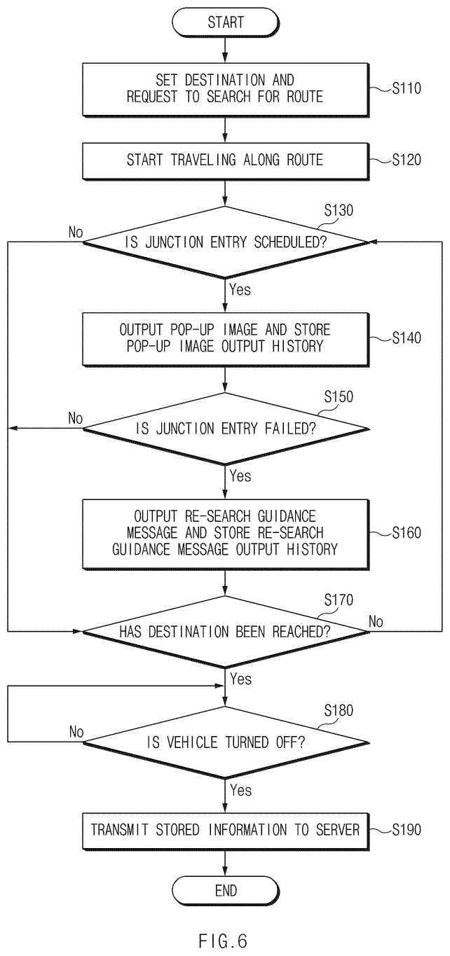

FIG. 6 is a diagram showing a vehicle control method according to an embodiment of the present disclosure.

As shown in FIG. 6, when the vehicle is started and the destination is set, the processor 150 may request the server 200 to search for the route to the destination (S110).

When receiving the route to the destination from the server 200, the processor 150 may control the vehicle to start traveling along the route (S120).

The processor 150 may determine whether the junction entry is scheduled based on the route to the destination (S130).

When determining that the junction entry is scheduled based on the route to the destination, the processor 150 may output the pop-up image including the junction entry guidance information (S140).

In S140, the processor 150 may store the route guidance information including the location information for each junction where the pop-up image was output and the history of the pop-up image output matching with the location information for each junction where the pop-up image was output.

The processor 150 may determine whether the scheduled junction entry is failed based on the route to the destination (S150).

When it is determined that the junction entry is scheduled, but the vehicle fails to enter the junction and travels deviating from the route, the processor 150 may output the re-search guidance message that re-searches the route to the destination (S160).

When determining that the re-search guidance message was output in S160, the processor 150 may store the route guidance information including the location information for each junction where the re-search guidance message was output and the re-search guidance message output history matching with the location information for each junction where the re-search guidance message was output.

The processor 150 may determine whether the destination has been reached (S170).

When determining that the destination has not been reached, the processor 150 may store the pop-up image output history for each junction depending on whether the junction entry is scheduled until reaching the destination, and may store the re-search guidance message output history for each junction depending on whether the junction entry fails.

When determining that the destination has been reached, the processor 150 may determine whether the vehicle is turned off (S180).

The processor 150 may transmit the stored information (the route guidance information) to the server 200 (S190).

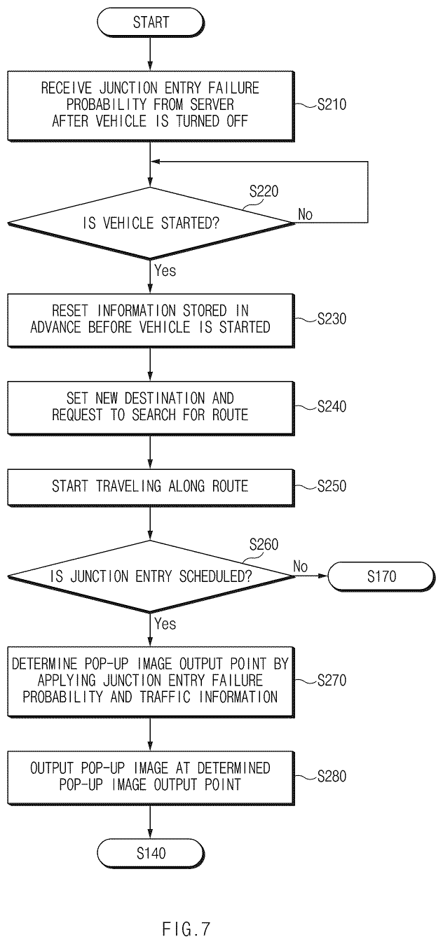

As shown in FIG. 7, when the vehicle is turned off and the wireless update is performed from the server 200, the processor 150 may receive the calculated entry failure probability for each junction (S210).

The processor 150 may determine whether the vehicle is started again after being turned off (S220).

When determining that the vehicle is started, the processor 150 may reset (delete) the information (the pop-up image output history information and the re-search guidance message output history information) stored before the vehicle is started (S230).

When the new destination is input, the processor 150 may request the server 200 to search for the route to the new destination (S240).

The processor 150 may control the vehicle to start traveling along the route to the new destination (S250).

The processor 150 may determine whether the junction entry is scheduled based on the route to the new destination (S260). When determining that the junction entry is not scheduled, the processor 150 may perform steps S170 to S190 in FIG. 6.

When determining that the junction entry is scheduled based on the route to the new destination, the processor 150 may determine the pop-up image output point based on the weight reflecting at least one of the entry failure probability for each junction or the traffic information, or any combination thereof received from the server 200 (S270).

According to one embodiment, in S270, the processor 150 may determine the pop-up image output point by reflecting the weight to the pop-up image output point (see Table 2) preset depending on the type of road.

According to one embodiment, when the processor 150 determines the pop-up image output point based on the weight reflecting the entry failure probability a for each junction, the pop-up image output point for each type of road may be calculated using Calculation Formula 1 to 3.

In other words, as the entry failure probability for each junction increases, the processor 150 may determine that the pop-up image output point is farther away from the junction than the preset pop-up image output point.

According to one embodiment, in S270, when the pop-up image output point is determined based on the weight reflecting the traffic information, the pop-up image output point for each type of road may be determined as shown in Table 3.

That is, the processor 150 may determine that as the travel speed decreases when the vehicle travels on the predetermined route including the junction, the pop-up image output point is farther from the junction than the preset pop-up image output point.

According to one embodiment, in S270, when the processor 150 determines the pop-up image output point based on the weight reflecting the entry failure probability for each junction and the traffic information, the pop-up image output point for each type of road may be determined as shown in Table 4.

In other words, as the entry failure probability for each junction increases and the travel speed decreases when the vehicle travels on the predetermined route including the junction, the processor may determine that the pop-up image output point is farther away from the junction than the preset pop-up image output point.

When the pop-up image output point is determined, the processor 150 may change the preset pop-up image output point to the determined pop-up image output point, and output the pop-up image via the output device 130 at the determined pop-up image output point (S280). The processor 150 may then perform operations S140 to S190 in FIG. 6.

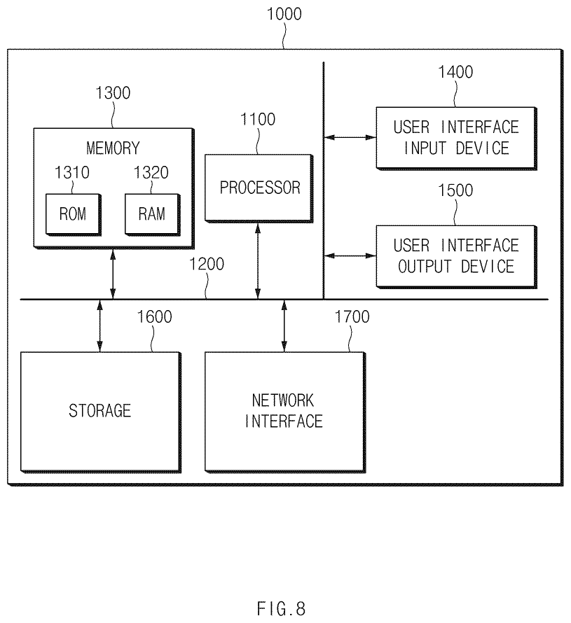

FIG. 8 illustrates a configuration of a computing system for executing a method according to an embodiment of the present disclosure.

With reference to FIG. 8, a computing system 1000 may include at least one processor 1100, a memory 1300, a user interface input device 1400, a user interface output device 1500, storage 1600, and a network interface 1700 connected via a bus 1200.

The processor 1100 may be a central processing unit (CPU) or a semiconductor device that performs processing on commands stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM. The exemplary storage medium is coupled to the processor 1100, which may read information from, and write information to, the storage medium. In another method, the storage medium may be integral with the processor 1100. The processor and the storage medium may reside within an application specific integrated circuit (ASIC). The ASIC may reside within the user terminal. In another method, the processor and the storage medium may reside as individual components in the user terminal.

The description above is merely illustrative of the technical idea of the present disclosure, and various modifications and changes may be made by those skilled in the art without departing from the essential characteristics of the present disclosure.

Therefore, the embodiments disclosed in the present disclosure are not intended to limit the technical idea of the present disclosure but to illustrate the present disclosure, and the scope of the technical idea of the present disclosure is not limited by the embodiments. The scope of the present disclosure should be construed as being covered by the scope of the appended claims, and all technical ideas falling within the scope of the claims should be construed as being included in the scope of the present disclosure.

The device and the method for controlling the vehicle according to the embodiment of the present disclosure may determine the output point of the pop-up image that guides the junction entry information such that the driver may easily recognize the pop-up image and safely enter the junction.

The device and the method for controlling the vehicle according to the embodiment of the present disclosure may reduce the traffic congestion by preventing the unnecessary travel such as the U-turn, the re-entry, and the re-joining caused by the driver failing to enter the junction.

The device and the method for controlling the vehicle according to the embodiment of the present disclosure may fundamentally prevent the situation in which the driver unreasonably attempts to perform the lane change to avoid missing the junction entry timing, thereby reducing the probability of the collision accident with another vehicle traveling in the line where the vehicle is traveling or the line adjacent thereto.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

1. A device for controlling a vehicle, the device comprising:
a communication device in communication with a server; and
a processor configured to:
transmit at least one of route guidance information provided while the vehicle travels on a route to a destination, or traffic information on the route, or a combination thereof, to the server; and
determine an output point of a pop-up image based on a weight reflecting at least one of an entry failure probability or the traffic information, or a combination thereof, received from the server.

2. The device of claim 1, wherein the processor is further configured to:
output the pop-up image including junction entry guidance information when determining that a junction entry is scheduled based on the route to the destination; and
store the route guidance information including location information for each of one or more junctions where the pop-up image was output, and a history of the pop-up image output matching with the location information.

3. The device of claim 1, wherein the processor is further configured to:
output a re-search guidance message when it is determined that a junction entry is scheduled based on the route to the destination, and the junction entry has failed; and
store the route guidance information including location information for each junction where the re-search guidance message was output and a history of the re-search guidance message output matching with the location information.

4. The device of claim 1, wherein the processor is further configured to transmit the route guidance information to the server when determining that the vehicle is turned off after reaching the destination.

5. The device of claim 1, wherein the processor is further configured to receive the entry failure probability calculated by the server based on the route guidance information for each junction received from one or more vehicles.

6. The device of claim 4, wherein the processor is further configured to reset the route guidance information transmitted to the server when determining that the vehicle is started again after being turned off.

7. The device of claim 1, wherein the processor is further configured to determine the pop-up image output point by reflecting the weight to a pop-up image output point preset depending on a type of road.

8. The device of claim 2, wherein the processor is further configured to determine that the pop-up image output point is farther away from the junction than a preset pop-up image output point as the entry failure probability increases.

9. The device of claim 2, wherein the processor is further configured to determine that the pop-up image output point is farther away from the junction than a preset pop-up image output point as a travel speed decreases when the vehicle travels on a predetermined route including the junction.

10. The device of claim 1, wherein the processor is further configured to control the pop-up image to be output via an output device at the determined pop-up image output point.

11. A method for controlling a vehicle, the method comprising:
transmitting, by a processor, at least one of route guidance information provided while the vehicle travels on a route to a destination or traffic information on the route, or a combination thereof, to a server; and
determining, by the processor, an output point of a pop-up image based on a weight reflecting at least one of an entry failure probability or the traffic information, or a combination thereof, received from the server.

12. The method of claim 11, further comprising:
outputting the pop-up image including junction entry guidance information when determining that a junction entry is scheduled based on the route to the destination, and storing the route guidance information including location information for each of one or more junctions where the pop-up image was output, and a history of the pop-up image output matching with the location information.

13. The method of claim 11, further comprising:
outputting a re-search guidance message when it is determined that a junction entry is scheduled based on the route to the destination, and the junction entry has failed, and storing the route guidance information including location information for each junction where the re-search guidance message was output and a history of the re-search guidance message output matching with the location information.

14. The method of claim 11, further comprising:
transmitting the route guidance information to the server when determining that the vehicle is turned off after reaching the destination.

15. The method of claim 11, further comprising:
receiving the entry failure probability calculated by the server based on the route guidance information for each junction received from one or more vehicles.

16. The method of claim 14, further comprising:
resetting the route guidance information transmitted to the server when determining that the vehicle is started again after being turned off.

17. The method of claim 11, wherein the pop-up image output point is determined by reflecting the weight to a pop-up image output point preset depending on a type of road.

18. The method of claim 12, wherein the pop-up image output point is determined to be farther away from the junction than a preset pop-up image output point as the entry failure probability increases.

19. The method of claim 12, wherein the pop-up image output point is determined to be farther away from the junction than a preset pop-up image output point as a travel speed decreases when the vehicle travels on a predetermined route including the junction.

20. The method of claim 11, further comprising:
controlling the pop-up image to be output via an output device at the determined pop-up image output point.
